(19) United States
(12) Patent Application Publication
(10) Pub. No.: US 2012/0009554 A1
(43) Pub. Date: Jan. 12, 2012

(54) INSTRUCTIONAL SHOELACE TYING SYSTEM

(76) Inventor: Tarrus Johnson, Emeryville, CA (US)

(21) Appl. No.: 13/155,391

(22) Filed: Jun. 8, 2011

Related U.S. Application Data
(60) Provisional application No. 61/399,201, filed on Jul. 8, 2010.

(51) Int. Cl. G09B 19/00; A43B 3/00; A43C 1/00

(52) U.S. Cl. 434/260; 24/713.4; 36/83

(57) ABSTRACT

An instructional shoelace tying system. Identical identifiers are positioned on a right free end of a shoelace. Different identical identifiers are then positioned on the left free end of the shoelace. Another identifier might be positioned between the first set of identifiers. Kids can utilize such generally elongated hollow identifiers to quickly learn how to tie their shoelaces.

### CLAIM OF PRIORITY

This application claims priority from U.S. Provisional Patent Application No. 61/399,201 filed Jul. 8, 2010, the entirety of the specification of which is hereby incorporated by reference as if fully set forth in the present specification.

### BACKGROUND OF THE INVENTION

The present invention relates generally to shoelace tying systems and more specifically to instructional shoelace systems for teaching children how to tie their shoelaces.

Many children typically between ages two and five continue to have difficulty tying their shoelaces. This difficulty arises partly because the shoelace tying process is sequential. Many children may understand the first step of the shoelace tying process but cannot easily comprehend subsequent steps.

Kids also have smaller hands and cannot easily manipulate their shoelaces. Many kids also do not have sufficient hand-to-eye coordination to accomplish what might seem to them as a very daunting task.

As noted above, many children can comprehend the first step of the shoelace tying process. This first step involves crossing of one free end over another free end of the shoelace, a step typically referred to as “crisscross apple sauce.”

Specifically, once the foot is placed in a shoe, with all eyelets of the shoe threaded with the shoelace, one free end, namely the left lace, is held in the left hand and the other free end, namely the right lace, is held in the right hand. The right lace is passed over the left lace and thereafter passed backward and underneath the left lace and then pulling tightly.

It is at this point that many children become overwhelmed. After the crisscross applesauce step, each lace must be looped into a bunny ear. The bunny ears must be held in both hands. The bunny ears must then be passed over each other, etc., etc., etc., until the shoelace tying process is complete.

There is a need to address one or more of the foregoing disadvantages of conventional systems and methods, and the present invention meets this need.

### BRIEF SUMMARY OF THE INVENTION

Various aspects of a shoelace tying system can be found in exemplary embodiments of the present invention.

In a first embodiment, a shoelace for tying a shoe is passed through eyelets of a shoe. The resulting free ends are a right free end and a left free end of the shoelace. After the “crisscross apple sauce” step, a first set of two identical identifiers are positioned on the right free end of the shoelace.

A second set of two identical identifiers are then positioned on the left free end of the shoelace. A third single identifier might be positioned between the first set of identifiers in a further embodiment. Note that the first, second and third identifier sets are distinct from each other.

The identifiers can be employed by users such as young children between the ages of two and five to learn how to tie shoelaces. The identifiers are also slidable over the shoelaces and can identify suitable shoelace positions for forming bases of loops for tying the shoelaces.

In a further embodiment, the identifiers might comprise an elongated hollow tube sized and adapted to receive the shoelace so that said hollow tube is slidable to respective positions for forming bases for the loops. In this manner, kids can quickly comprehend the sequential shoelace tying process and can coordinate and accomplish what might otherwise appear insurmountable to them.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

FIG. 1 shows an instructional shoelace tying system in accordance with an exemplary embodiment of the present invention.

FIG. 2 illustrates a shoe as threaded by a shoelace before use in accordance with an exemplary embodiment of the present invention.

FIG. 3 illustrates an instructional shoelace tying system in accordance with exemplary embodiments of the present invention.

FIG. 4 illustrates a further tying sequence of the instructional shoelace tying system of FIG. 3 in accordance with an exemplary embodiment of the present invention.

FIG. 5 illustrates a further tying sequence for the instructional shoelace tying system of FIG. 3 in accordance with exemplary embodiments of the present invention.

FIG. 6 illustrates a further tying sequence for the instructional shoelace tying system of FIG. 3 in accordance with exemplary embodiments of the present invention.

FIG. 7 illustrates a completely tied shoelace based on the instructional shoelace tying system of FIG. 3 in accordance with exemplary embodiments of the present invention.

FIG. 8 illustrates an instructional shoelace tying system in accordance with an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

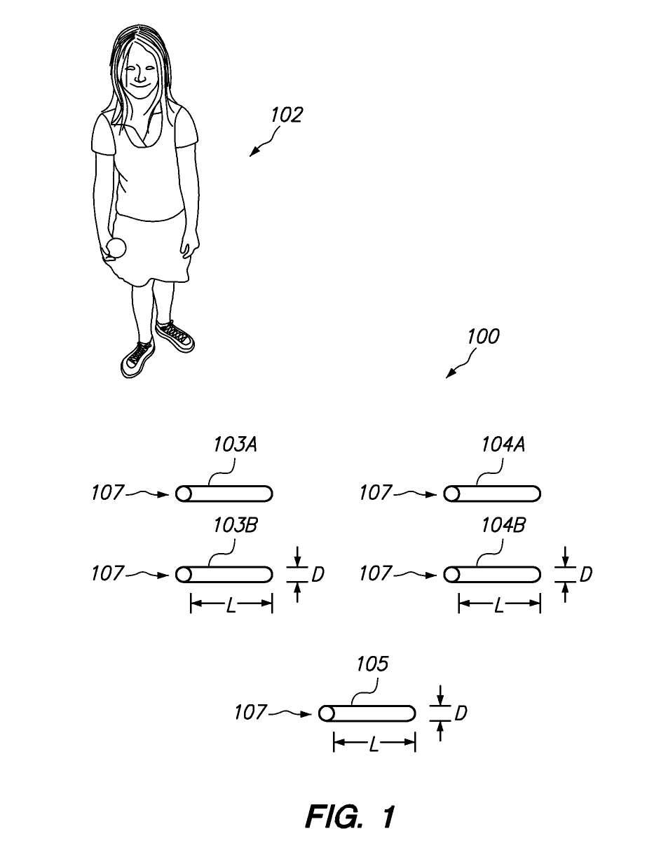

FIG. 1 shows instructional shoelace tying system 100 in accordance with an exemplary embodiment of the present invention.

In FIG. 1, among other components, instructional shoelace tying system 100 comprises a number of identifiers namely identifiers 103A and 103B, identifiers 104A and 104B and identifier 105. In this embodiment, identifier 103A and identifier 103B are a set with the identifiers working in conjunction with each other.

Identifier 104A and identifier 104B are also a set with the identifiers working cooperatively with each other. Identifier 105 is a single set identifier.

Each one of the identifiers is configured and adapted to receive a shoelace and is slidable over the shoelace to any suitable location. Such a location can indicate a shoelace area that might be held by a young child or identify a base of a loop, for example.

In this manner, a child such as user 102 can utilize identifiers 103A, 103B, 104A, 104B and 105 for quickly tying and thereafter learning to tie shoelaces. Once the child becomes adept, the identifiers can be removed from the shoelace.

In FIG. 1, as shown, each identifier 103A, 103B, 104A, 104B and 105 is a generally elongated hollow tube formed from polyurethane, silicone, polyvinylchloride, or other elastomeric material consistent with the spirit and scope of the present invention.

Each of identifier 103A, 103B, 104A, 104B and 105 also includes central hole 107 that is itself elongated extending lengthwise in a longitudinal direction though the elongated hollow tube. The term “elongated” as used herein indicates that an identifier has a substantial length relative to its width.

An exemplary length L of each identifier is about 0.5 inches long while an exemplary diameter D of central hole 107 is about 0.125 inches. The wall thickness (not shown) of each identifier is generally configured so that it is substantially thin to be manipulable by the smaller hands of young children.

One skilled in the art will realize that the aforementioned dimensions are exemplary and other suitable dimensions depending upon the shoelace type may be employed consistent with the spirit and scope of the present invention.

As noted above, identifier 103A and identifier 103B constitute a set, identifier 104A and identifier 104B are another set and identifier 105 is a single identifier set. In one embodiment, the identifiers of each set are identical while each set of identifiers is distinct or different from the other identifier sets. As an example, identifier 103A and identifier 103B are identical but different from identifiers 104A and 104B, which are identical and are also different from identifier 105.

As an example, the set comprising identifiers 103A, 103B may have an identical color such as red while the set of identifiers 104A, 104B may be blue and single set identifier 105 might be green. One skilled in the art will realize that alternative configurations that are not identical can be used so long as said alternative configurations maintain complements between two identifiers of a set.

For example, the identifiers may be matching sets with each matching set being distinct. A sporting theme might be utilized in which case identifier 103A and identifier 103B may be a baseball bat and baseball, respectively; while identifier 104A and identifier 104B might be a football helmet and a football, respectively; while identifier 105 is a tennis racket.

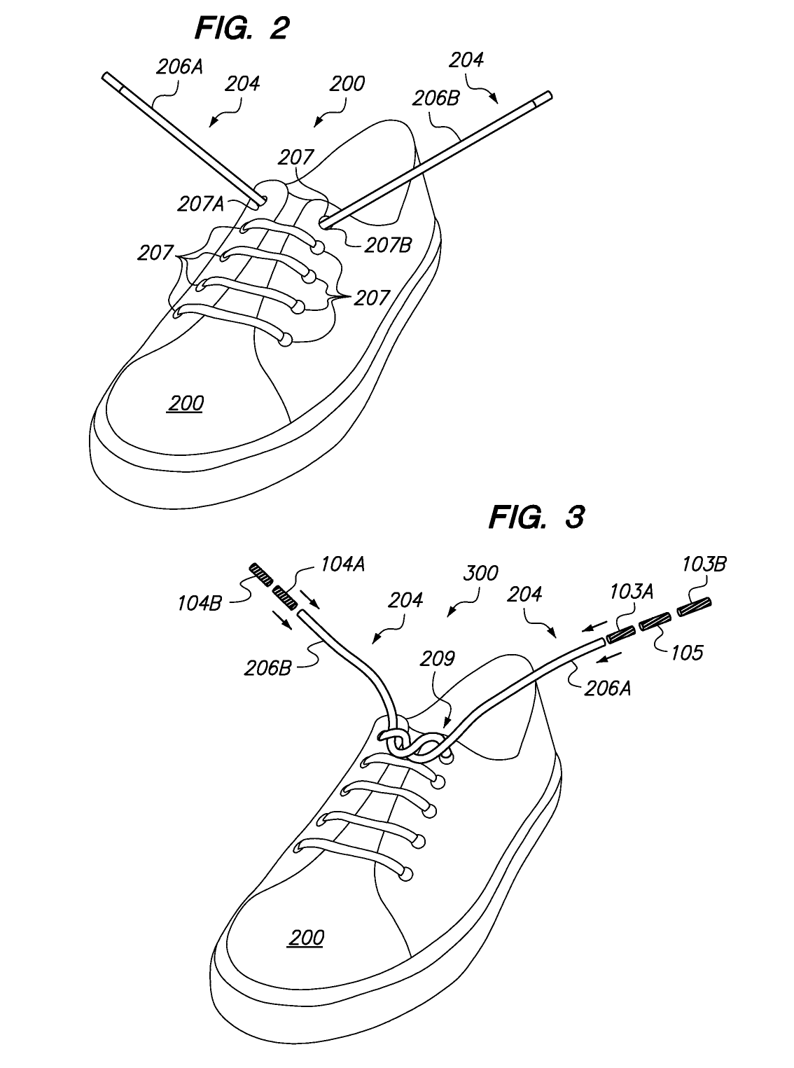

FIG. 2 illustrates shoe 200 as threaded by shoelace 204 before use in accordance with an exemplary embodiment of the present invention.

In FIG. 2, user 102 (FIG. 1) has employed shoelace 204 for threading through eyelets 207 of shoe 200. Specifically, shoelace 204, which is a single shoelace, is threaded beginning at eyelet 207A through eyelets 207 and ending with a free end of the shoelace that exits via outlet 207B.

The right free end namely right end 206A is threaded through eyelet 207A and left free end 206B is threaded through eyelet 207B. As used herein, a right end shoelace refers to the free end of a shoelace to the right of user 102 when the user's foot is inserted into shoe 200. A left end shoelace refers to the free end of a shoelace to the left of user 102 when user 102's foot is inserted into shoe 200.

Shoelace 204 can be of any type with a flat cross-section or round cross-section or made of leather, cotton, hemp, jute or synthetic fibers. Eyelets 207, 207A and 207B might be hooks and other similar type devices for securing shoelace 204.

FIG. 3 illustrates instructional shoelace tying system 300 in accordance with exemplary embodiments of the present invention.

In FIG. 3, as shown, instructional shoelace tying system comprises shoe 200, shoelace 204 of FIG. 2 and identifiers 103A, 103B, 104A, 104B, 105 of FIG. 1. In the present exemplary embodiment, identifiers 103A and 103B are colored red, identifiers 104A and 104B are blue and identifier 105 is green.

Here, user 102 has performed a crisscross apple sauce 209 to cross right end 206A over left end 206B of shoelace 204. Consequently, right end 206A ends up on user 102's left hand while left end 206B ends up on user 102's right hand.

In FIG. 3, right end 206A of shoelace 204 is shown receiving identifiers 103A and 103B. Right end 206A also receives identifier 105, which is positioned between identifier 103A and identifier 103B. As shown, left end 206B of shoelace 204 receives identifier 104A and identifier 104B.

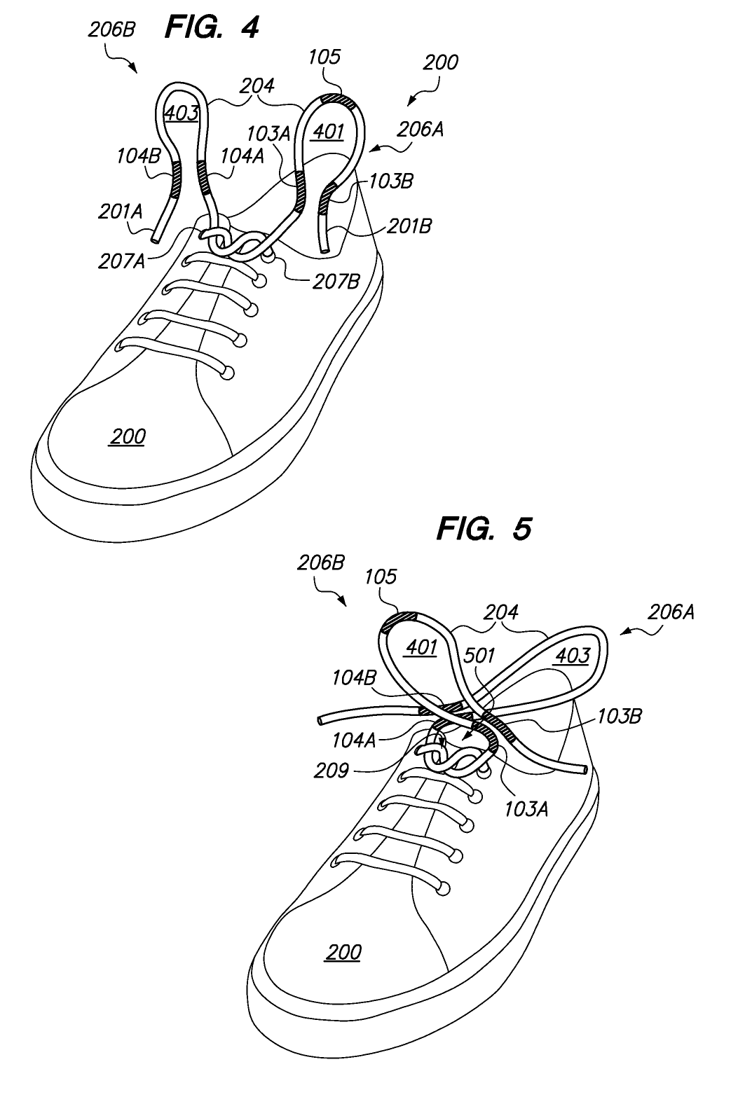

Once crisscross 209 has been performed and identifiers are slid over shoelace 204, user 102 is now ready to position and space apart the identifiers on the respective left end 206B and right end 206A of shoelace 204 as will be illustrated with reference to FIG. 4.

FIG. 4 illustrates a further tying sequence of instructional shoelace tying system 300 of FIG. 3 in accordance with an exemplary embodiment of the present invention.

In FIG. 4, specifically, the identifiers of FIG. 3 are spaced out and corresponding “bunny ears” or loops are formed. Here, “bunny ears” namely loop 401 and loop 403 are formed by right end 206A and left end 206B, respectively.

On right end 206A, the first red identifier 103A is slid lower and closer to eyelet 207B. The second red identifier 103B is spaced apart from identifier 103A and is positioned higher and closer to aglet 201B of right end 206A. The green identifier 105 is centered between the two red identifiers 103A and 103B.

In one embodiment, the identifiers are slidable such that identifier positions can be adjusted until a suitable position is reached. On left end 206B, the blue identifier 104A is positioned lower toward eyelet 207A while the blue identifier 104B is positioned higher toward aglet 201A.

Unlike conventional systems, identifiers 103A, 103B, 105, 104A and 104B are all slidable on the respective right end 206A or left end 206B of shoelace 204. That is, right identifier 103A can be slid slightly upwards or downwards to correspond to a location of right identifier 103B.

The diameters of all of the identifiers are loose enough to allow them to manually be slid backwards and forwards on shoelace 204 but tight enough to remain in a desired or suitable location once force applied to the identifier is removed. In this manner, user 102 can make suitable adjustments to properly position the identifiers so that the loops formed are not too big or too little so as to accomplish proper tying.

In an alternate embodiment, the identifiers may be fixed and not slidable. Suitable predetermined positions may be selected and identifiers located at such positions. For example, an identifier may be a portion of a shoelace colored differently from the color of the shoelace.

In operation, once proper positioning of the identifiers has been accomplished, user 102 begins by grasping red identifier 103A and bringing it in contact with red identifier 103B to form loop 401 as shown. Such loops are typically referred to as a “bunny ears.”

Similarly, user 102 grasps blue identifier 104A and blue identifier 104B and brings them in contact to form loop 403. Herein lies an advantage of the invention. User 102 can immediately comprehend how to form the loop because the user recognizes that the matching identifiers can be brought together to form a loop.

That is, user 102 understands that since the red color of identifier 103A and that of identifier 103B are identical, then those two members can be brought in contact to form a loop. Similarly, user 102 can readily recognize that identifiers 104A and 104B are blue and so those identifiers can be brought into contact to form the loop 403.

The position of each of identifiers 104A, 104B, 103A and 103B represents a base of loops 401 and 403 and indicates locations for user 102 to grasp the shoelace. By grasping the shoelace at identified locations to bring bases of each loop in contact with each other, loop 401 and loop 403 are readily formed. This is but an exemplary implementation of the present invention.

As previously noted, the identifiers need not be the same. They can simply be matching. An example of a matching identifier set is a king/queen set. Another example of a matching identifier is a basketball matched with a basketball hoop logo or a baseball bat matched with a baseball logo. Once the “bunny ears” have been formed, user 102 proceeds to the next sequence of the tying process described with reference to FIG. 5.

FIG. 5 illustrates a further tying sequence for instructional shoelace tying system 300 of FIG. 3 in accordance with exemplary embodiments of the present invention.

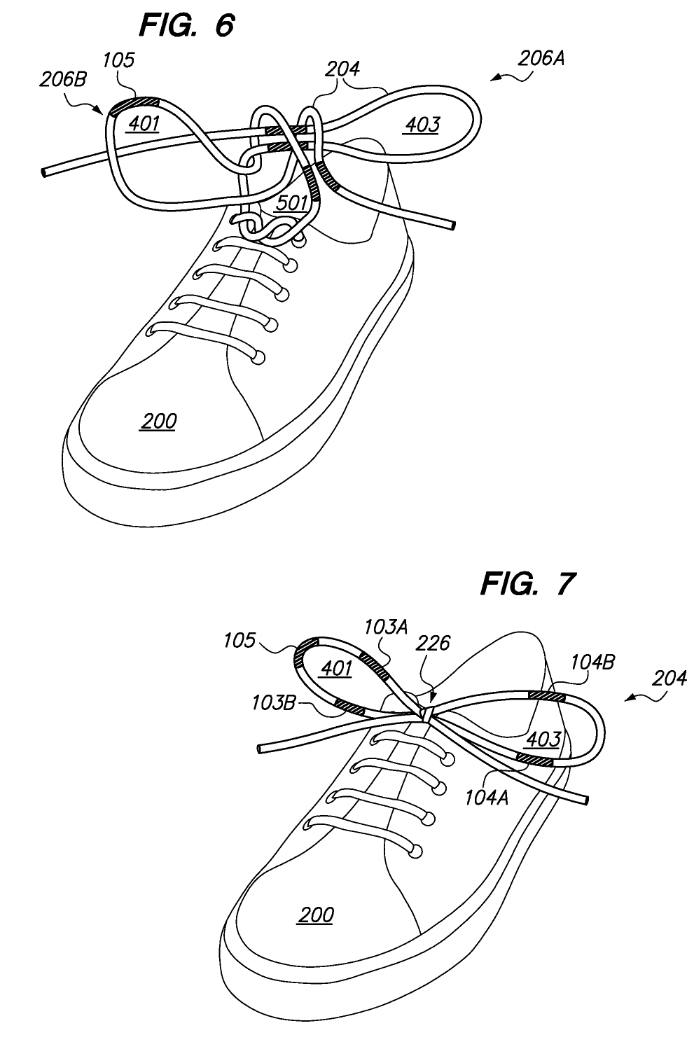

In FIG. 5, specifically, after “bunny ears” of FIG. 4 are formed, loops 401 and 403 can be crossed. In particular, user 102 crosses loop 403 of right end 206A over loop 401 of left end 206B. As a result, a “bunny mouth” or knot hole 501 is created. As shown in FIG. 5, knot hole 501 is the aperture between crisscross apple sauce 209 and the cross-over of loop 403 and loop 401. Having crossed loop 403 over loop 401, user 102 can proceed to the next stage of the tying process as further described with reference to FIG. 6.

FIG. 6 illustrates a further tying sequence for instructional shoelace tying system 300 of FIG. 3 in accordance with exemplary embodiments of the present invention.

In FIG. 6, loop 401 of left end 206B and loop 403 of right end 206A are knotted. Specifically, referring to FIG. 5 and FIG. 6, user 102 grasps and passes green identifier 105 backwards and over right end 206A and loop 403 through knot hole 501 of FIG. 5.

User 102 identifies not only the appropriate loop, namely loop 401 of left end 206B, to use to initiate knotting but also identifies a portion of the loop, namely the center portion occupied by green identifier 105, for use with the sequence. User 102 can easily grasp green identifier 105 and pass it through knot hole 501 to tie the shoelaces as shown with respect to FIG. 6. The term “knotting” refers to interlacing two loops to form a knob for fastening. Once knotting is completed, user 102 simply pulls both ends of loops 401 and 403 tightly to tie the shoelace as shown with reference to FIG. 7.

FIG. 7 illustrates a completely tied shoelace 204 based on instructional shoelace tying system 300 of FIG. 3 in accordance with exemplary embodiments of the present invention.

In FIG. 7, loop 401 and loop 403 are completely tied by knot 226. Identifiers 104A and 104B are shown on loop 403 and identifiers 103A and 103 B are shown on loop 401.

Instructional shoelace tying system 300 of the present invention includes a rhyming mnemonic that accompanies the tying process as follows: “red to red,” “blue to blue,” “then blue on top,” “and pull green through.” “Now pull the laces tight, and you have tied your shoe.”

Although the claims have been described with respect to the preceding embodiments, one of ordinary skill in the art will understand that such preceding embodiments are only exemplary. Other embodiments are possible. For example:

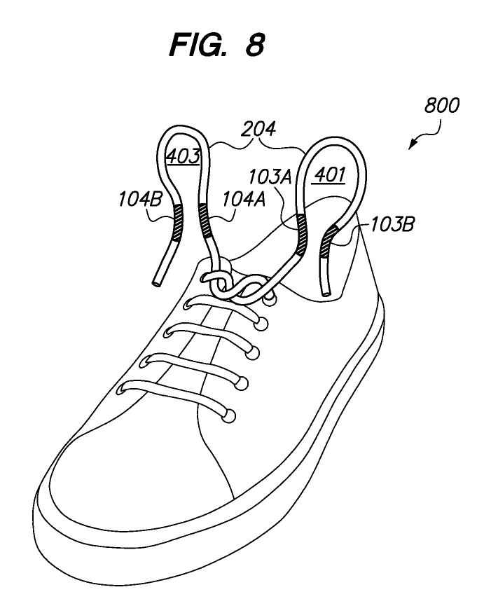

FIG. 8 illustrates instructional shoelace tying system 800 in accordance with exemplary embodiments of the present invention.

In FIG. 8, unlike the previous embodiments, only four identifiers 103A, 103B, 104A and 104B are employed. No identifier (e.g., green) centered between identifiers 103A and 103B is utilized.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A system for tying a shoelace, wherein said shoelace is threaded through eyelets of a shoe resulting in two free ends, namely a right end and a left end of the shoelace oppositely disposed to each other, the system comprising:
a first set of two identifiers that are matching, wherein the two matching identifiers are spaced apart on the right end of the shoelace to identify respective locations for bases of a first loop formed with the right end shoelace; and
a second set of two identifiers that are matching but different from the first set of identifiers, wherein the second set of identifiers are spaced apart on the left end of the shoelace to identify respective locations for bases of a second loop formed with the left end, and wherein the first loop and the second loop are knotted together in order to tie the shoelace.

2. The system of claim 1 further comprising
a third identifier different from the first and the second set of identifiers,
wherein the third identifier is centered between the first set of two identifiers on the first loop.

3. The system of claim 2 wherein the third identifier indicates to a user which one of the first and the second loops is used to initiate knotting.

4. A system comprising:
a first set of two identifiers that are matching, wherein the two matching identifiers are spaced apart on a right end of a shoelace to identify respective locations for forming bases for a first loop, wherein the two matching identifiers are slidable on said right end shoelace to determine said locations for forming said bases; and
a second set of two identifiers that are matching but different from the first set of identifiers, wherein the second set identifiers are spaced apart on the left end of the shoelace to identify respective locations for forming bases for a second loop, wherein the second set identifiers are slidable on said left end shoelace to determine said locations for forming said bases for said second loop and wherein the first loop and the second loop are knotted together in order to tie the shoelace.

5. The system of claim 4 further comprising
a third identifier different from the first and the second set of identifiers,
wherein the third identifier is centered between the two identifiers on the first loop.

6. The system of claim 5 wherein the third identifier indicates to a user that the first loop is used to initiate knotting.

7. The system of claim 4 wherein the first set of matching identifiers is used to form the first loop by bringing each matching identifier into contact with each other.

8. The system of claim 4 wherein the second set of matching identifiers is used to form the second loop by bringing each matching identifier into contact with each other.

9. The system of claim 4 wherein each identifier comprises a hollow tube;
a central hole, elongated and extending lengthwise in a longitudinal direction through said hollow tube;
said central hole being sized and adapted to receive said shoelace so that said hollow tube is slidable to said respective positions for forming bases of said first loop and second loop.

10. The system of claim 4 wherein said first set of two identifiers is red.

11. The system of claim 4 wherein said second set of two identifiers is blue.

12. The system of claim 5 wherein said third identifier is green.

13. A device for tying a shoelace, wherein said shoelace is threaded through eyelets of a shoe resulting in two free ends, namely a right end and a left end of the shoelace oppositely disposed to each other, the device comprising:
a hollow tube;
a central hole, elongated and extending lengthwise in a longitudinal direction through said hollow tube;
said central hole sized and adapted so that said right end and the left end of the shoelace is insertable into said central hole so that said hollow tube is slidable over said right end shoelace and said left end shoelace to indicate respective locations for forming bases of a first loop for the right end shoelace and a second loop for the left end shoelace, so that said first loop and second loop are knot-ablein order to tie said shoelace.

14. The device of claim 13 wherein said hollow tube is blue.

15. The device of claim 13 wherein said hollow tube is red.

16. The device of claim 13 wherein said hollow tube is green.

17. A shoe comprising:
a shoelace threaded through eyelets of said shoe resulting in two free ends, namely a right end and a left end of the shoelace oppositely disposed to each other;
a first set of two identifiers that are matching, wherein the two matching identifiers are spaced apart on a right end of a shoelace to identify respective locations for forming bases of a first loop, wherein the two matching identifiers are slidable on said right end shoelace to vary said locations for forming said bases; and
a second set of two identifiers that are matching but different from the first set of identifiers, wherein the second set of identifiers are spaced apart on the left end of the shoelace to identify respective locations for forming bases of a second loop, wherein the second set of identifiers is slidable on said left end shoelace to vary said locations for forming said bases of said second loop and wherein the first loop and the second loop are knotted together in order to tie the shoelace.

18. The shoe of claim 17 further comprising
a third identifier different from the first and the second set of identifiers,
wherein the third identifier is centered between the first set of identifiers on the first loop.
